(19) United States
(12) Patent Application Publication
(10) Pub. No.: US 2008/0131224 A1
(43) Pub. Date: Jun. 5, 2008

(54) Whirling head and its use

(75) Inventor: Gael Vouillamoz, Delemont (CH)

Correspondence Address: Clifford W. Browning, Suite 2800, One Indiana Square, Indianapolis, IN, 46204, US

(73) Assignee: Willemin-Macodel S.A.

(21) Appl. No.: 11/998,205

(22) Filed: Nov. 29, 2007

(30) Foreign Application Priority Data
Dec. 4, 2006 (EP) 06125304.3

(51) Int. Cl. B23C 3/32

(52) U.S. Cl. 409/74; 470/10; 29/27 C

(57) ABSTRACT

The frame of the whirling head comprises the rigid casing (7), in which the part (10) contains the drive pulley (15) solidly attached to the coupling member (17) connected to the drive shaft of the spindle (26). By means of the belt (19), this pulley (15) drives the pulley (8) solidly attached to the connecting cone (4), which in turn comprises the internal milling cutter (1) which cuts the thread of the screw shaft (27) supported between the bar advance unit (28) and the tailstock centre (29). The latter is mounted as an exchangeable tool on the return unit (32).

### TECHNICAL FIELD

The present invention relates to a whirling head with an internal milling cutter, mounted in a frame arranged to be fixed on a body of a spindle in an automatic machining centre, so that the drive shaft of the spindle drives said milling cutter during a whirling operation integrated in a working cycle of said centre. It also relates to the use of such a whirling head on the spindle of a five-axis machining centre.

### BACKGROUND OF THE INVENTION

The aim of the present invention is to rationalise and improve, in terms of efficiency, the production by machining of certain objects in the medical field, more precisely certain categories of bone screws. Bone screws are commonly used in surgery. The structures of the different types of these screws are currently standardised and their production is subjected to precise constraints. It is known, in particular, that the quality requirements for threading screw shafts require the use of the whirling technique, i.e. cutting the threads using internal milling cutters arranged eccentrically with their axes positioned obliquely in relation to the axis of the shaft. On the other hand, the structures of the screw heads are also standardised and require complex milling operations following a complex geometry, which must guarantee secure coupling with the screwing bit at the time of installation.

Currently, to fulfil these requirements, the whirling operations are generally conducted on Swiss turning machines, but the screw head milling operations must then be conducted, in a second step, on a regular milling machine. It has been considered before to make the screw threads by whirling on complex machines of a known type, such as five-axis machining centres with CNC control; however, the relative positions of the spindle and the back working unit, which are fixed in these machines, do not allow the whirling operation to be performed when the set length of the thread requires work with the tailstock centre of the back working unit.

The present invention provides a solution to this difficulty. It allows bar production of standardised bone screws of considerable length on a conventional five-axis machining centre, in a single cycle of programmed operations that automatically follow one another. Production times are then reduced to their minimum values.

### SUMMARY OF THE INVENTION

To achieve this aim, the invention provides a whirling head comprising an internal milling cutter, mounted in a frame arranged to be fixed to the body of a spindle in an automatic machining centre, so that the drive shaft of the spindle drives said milling cutter during a whirling operation integrated in a working cycle of said centre, wherein said frame comprises an elongated casing containing pivoting means at either end, wherein said pivoting means support and guide, at one of said ends, said milling cutter and, at the other end, a driving member equipped with means for coupling with the shaft of the spindle, and wherein the frame further comprises an inner link for the driving member to drive the rotation of the milling cutter, and indexing means on the outside capable of cooperating with matching means of the body of the spindle in order to fix the frame in a predetermined position in relation to the body of the spindle when positioning the whirling head at the start of said whirling operation.

The axes of the driving member and the internal milling cutter are preferably parallel.

The driving member may be formed by a first synchronous pulley, and said link may comprise a second synchronous pulley coupled with the milling cutter and a synchronous belt tensed between said first and second synchronous pulleys.

Said pivoting means may be bearings with oblique contact.

The coupling means and the indexing means may be formed so as to be connected to matching means of the spindle for the whirling operation and to be separated from the latter automatically, by the programmed action of a tool-changing arm associated with said machining centre.

The invention is also concerned with the use of said whirling head on a spindle of a five-axis machining centre for bar machining, in one cycle, of screws with lengths requiring a whirling operation with a tailstock and a milling of the screw head, the milling of the screw head being performed by the spindle equipped for this operation with a conventional milling cutter, moving according to a conventional programme, and in particular with the use of said whirling head for machining a bone screw with a milled head.

### BRIEF DESCRIPTION OF THE DRAWINGS

One embodiment of the invention is described below as a non limitative example, in reference to the appended drawings, wherein:

FIG. 1 is a section view of the whirling head;

FIG. 2 is a front perspective view of the internal milling cutter added to the head of FIG. 1;

FIG. 3 is a perspective view of the whirling head fixed to the spindle of a five-axis machining centre;

FIG. 4 is a partial cross-section front view showing three essential units of the five-axis machine during the whirling operation; and

FIG. 5 is a partial perspective view of the five-axis machine with its conventional equipment.

### DETAILED DESCRIPTION OF EMBODIMENTS OF THE INVENTION

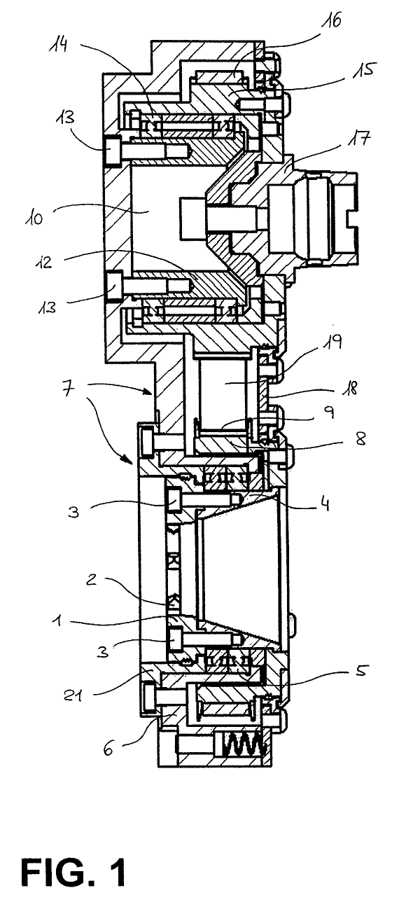

The section view of FIG. 1 shows the main elements of the whirling head provided as an example. An internal milling cutter 1 equipped with tips 2 is fixed and centred by screws 3 against the rear face of a tubular support with an inner cone 4 which rotates between ball bearings 5, for example made from ceramic. The fixed outer raceways of the bearings 5 are housed in a socket-shaped part 6 of a metal casing 7 forming the main part of the frame of the whirling head. The end of the cone 4 bears a hollow pulley 8 equipped with teeth 9 and comprising a tubular part that covers the socket-shaped part 6 of the casing 7. This is an elongated part with a central portion in the form of a chute having a bottom and a continuous side wall, in which the tubular element 6 projects at one end, surrounded 180 degrees by the wall of the chute. At the other end, the part 7 forms a circular container 10 delimited by the outer side wall of the part. In the bottom of this container is fixed a cylindrical part 12 which acts as a hub, retained by screws 13, the outer surface of which has ball bearings 15 supporting and guiding a second hollow pulley 15 equipped with teeth 16 on the outside. This hollow pulley 15 is solidly attached, by its outer side, to a bottom 17 forming a coupling member. The casing 7 is closed on the side of the cone 4 and of the coupling member 17 by a flat cover 18 equipped with openings for passing the projecting parts of the rotating bodies 8, 4, 1 on the one hand and 17, 15 on the other hand. These rotating members are supported with their axes parallel in the casing 7. The cover 18 can be lifted in order to install a synchronous belt 19 on the pulleys, which ensures that the milling cutter 1 is driven from the member 17.

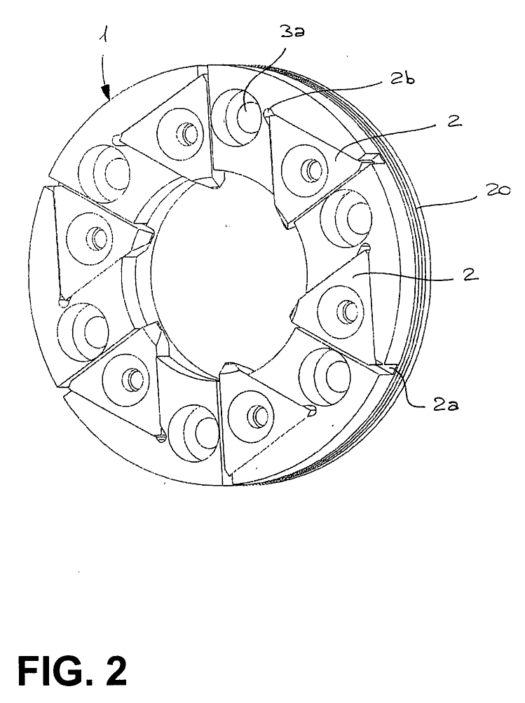

FIG. 2 shows the internal milling cutter 1 with six triangular tips 2 engaged in housings of the rear face of the milling cutter. It can be seen that, for each tip, one of its crests is prominent in the central bore in order to cut the bar to be threaded as will be described below. Another crest extends projecting into a radial undercut 2a of the milling cutter, and the third crest is engaged in an elongated hollow 2b made in the rear face of the milling cutter. The rear face of the milling cutter comprises six cylindrical housings 3a in which the heads of the screws 3 are accommodated. The side face of the same comprises a series of grooves 20 forming a labyrinth, cooperating with a ring 21 (FIG. 1) fixed to the casing 7 and surrounding the milling cutter.

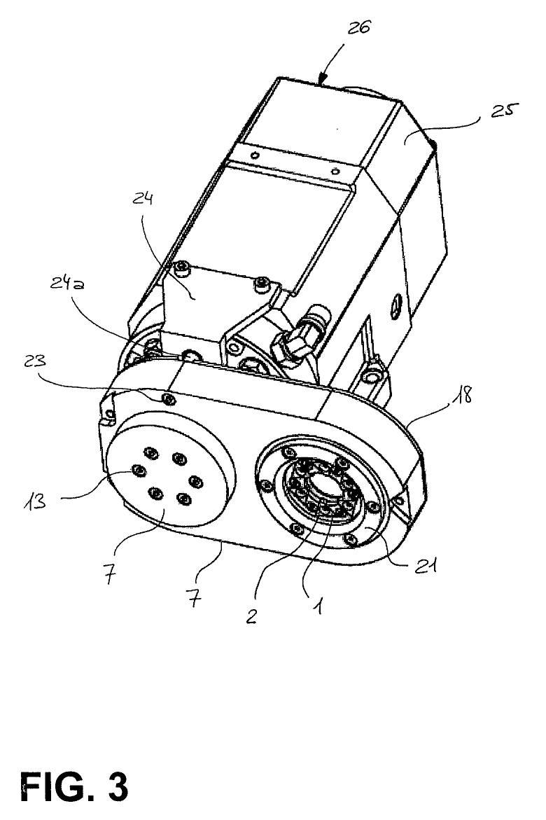

The whirling head is shown in FIG. 3 fixed to the body 25 of a spindle 26. The very compact arrangement of the frame obtained with the described construction is remarkable. A calibrated opening 23 constitutes indexing means cooperating in a very precise manner with matching indexing means 24, 24a fixed to the body 25 of the spindle 26. As will be seen below, when placed on the body 25, the coupling member 17 with its tubular projection on the slightly conical outer face (according to the HSK E40 standard) and its bore with an inner groove is engaged and linked to the drive shaft of the spindle so that the matching indexing means 23, 24, 24a perfectly complement the isostatic assembly of the member 17 on the spindle while ensuring that it is driven.

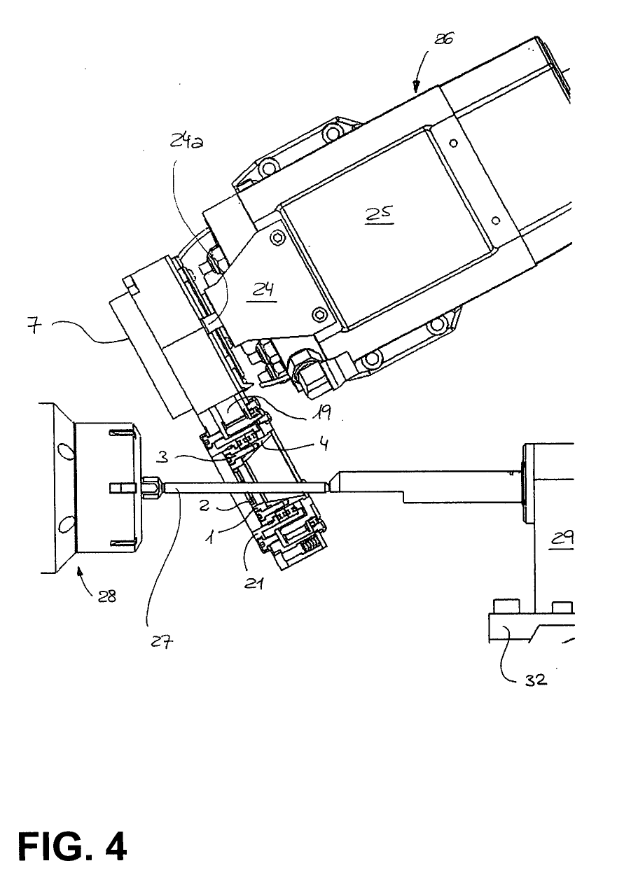

FIG. 4 shows how, with the described head fixed to the spindle 26, a whirling operation is performed on a shaft 27 made from a bar of material to be machined, driven in rotation and guided by a spindle stock 28. The latter belongs to a bar advance axis of a five-axis machine. The shaft 27 is supported at its front end by a tailstock 29.

The axis of rotation of the spindle 26 is tilted on that of the bar 27 by an angle that matches the rising angle of the thread to be cut by the internal milling cutter 1. On the other hand, this axis is offset laterally so as to set the eccentric position of the milling cutter 1 in relation to the bar 27. The diameter of the thread is determined by this eccentricity of the whirling crown, and thus by the centre-to-centre distance between the bar and the milling cutter. The milling cutter turns at high speed around the bar to be threaded. The latter is driven with a slow rotation synchronised with the axial advance of the tool, allowing the pitch of the thread to be defined. The part of the whirling head shown in a section view in FIG. 4 shows how the described compact construction allows the milling cutter 1 to be driven by the synchronous belt 19 with minimum bulk, guaranteeing the rigidity and precision of the positions, which guarantees high-quality production of bone screws.

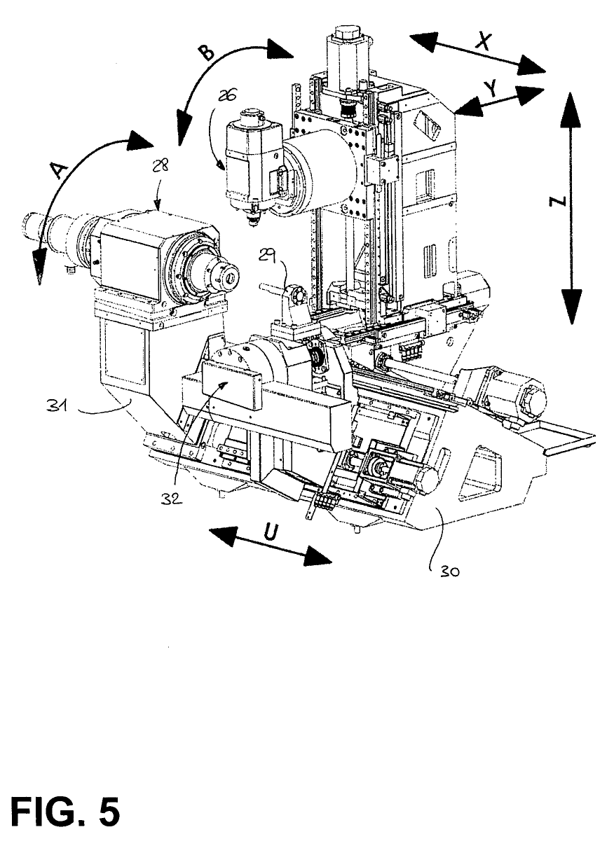

This performance can be easily achieved using a conventional machining centre such as shown in FIG. 5. In this machine, the rigid base 30 bears, on a console 31 solidly attached to it, the bar advance axis 28 already shown in FIG. 4. This axis defines the direction X. The console 31 defines a horizontal plane parallel to the axis X. It guides an element 32 called back working unit capable of sliding in the direction X over a short distance (U axis). This unit can also rotate about a horizontal axis perpendicular to X (Y axis). It can be equipped with a clamping collet or a return vice, but can also be equipped with a tailstock centre system such as shown as 29 in FIG. 4. The shaft of the tailstock centre has an undercut that aims to prevent interaction with the whirling head, considering the angle of tilt of the threads.

FIG. 5 shows the spindle 26 equipped with a single milling cutter. This unit is movable according to four axes X, Y, Z and B and does not require further description since it is part of a known machine. When using the whirling head described to produce a bone screw of considerable length, the spindle 26 and the back working unit 32 are initially placed in the positions of FIG. 4. The bar to be machined (not shown in FIG. 5) is moved forward and its end is secured by insertion in the tailstock centre 29. The screw is threaded by moving the spindle 26 along the X axis. Then, the spindle 26 is released. The whirling head, separated from the spindle, is reinserted in a magazine (not shown) by means of a tool-changing arm; after this, the spindle being equipped with a parting tool, the duly threaded bar segment 27 is cut at the level of the unit 28. It is understood that the head of the screw can be milled using a suitable tool mounted on the drive shaft of the spindle 26 during the same cycle of operations as that including whirling. This operation can take place before or after the threading operation.

The entire process can be controlled in a flexible, completely automatic manner by programming the existing axes.

According to the embodiment shown in the figures, the geometry of the whirling head allows the screw to be machined with a helix angle of up to 28°.

1. Whirling head comprising an internal milling cutter, mounted in a frame arranged to be fixed to the body of a spindle in an automatic machining centre, so that the drive shaft of the spindle drives said milling cutter during a whirling operation integrated in a working cycle of said centre, wherein said frame comprises an elongated casing containing pivoting means at either end, wherein said pivoting means support and guide, at one of said ends, said milling cutter and, at the other end, a driving member equipped with means for coupling with the shaft of the spindle, and wherein the frame further comprises an inner link for the driving member to drive the rotation of the milling cutter, and indexing means on the outside capable of cooperating with matching means of the body of the spindle in order to fix the frame in a predetermined position in relation to the body of the spindle when positioning the whirling head at the start of said whirling operation.

2. Whirling head according to claim 1, wherein the axes of the driving member and the internal milling cutter are parallel.

3. Whirling head according to claim 2, wherein the driving member is formed by a first synchronous pulley, and wherein said link comprises a second synchronous pulley coupled with the milling cutter and a synchronous belt tensed between said first and second synchronous pulleys.

4. Whirling head according to claim 1, wherein said pivoting means are bearings with oblique contact.

5. Whirling head according to claim 1, wherein the coupling means and the indexing means are formed so as to be connected to matching means of the spindle for the whirling operation and to be separated from the latter automatically, by the programmed action of a tool-changing arm associated with said machining centre.

6. Use of the whirling head according to claim 1, on a spindle of a five-axis machining centre for bar machining, in one cycle, of screws with lengths requiring a whirling operation with a tailstock and a milling of the screw head, the milling of the screw head being performed by the spindle equipped for this operation with a conventional milling cutter, moving according to a conventional programme.

7. Use according to claim 6 for machining a bone screw with a milled head.
